(19) United States
(12) Patent Application Publication
(10) Pub. No.: US 2008/0118207 A1
(43) Pub. Date: May 22, 2008

(54) Optical Fiber Module

(75) Inventors: Yoshinori Yamamoto, Kanagawa (JP); Toshiyuki Miyamoto, Kanagawa (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi, Osaka (JP)

(21) Appl. No.: 11/795,596

(22) PCT Filed: Jan. 23, 2006
(86) PCT No.: PCT/JP06/00929

§ 371 Date: Jul. 19, 2007

(30) Foreign Application Priority Data
Jan. 24, 2005 (JP) 2005-015279

(51) Int. Cl. G02B 6/00; G02B 6/42

(52) U.S. Cl. 385/88; 385/135

(57) ABSTRACT

An optical module is connected to external optical equipment with low loss, and excess length portion of a pigtail fiber does not cause an obstruction. The optical fiber module includes (1) a functional optical fiber; (2) a receptacle configured and arranged to accommodate the functional optical fiber; (3) a pigtail fiber that is connected to the functional optical fiber, and disposed so as to be extendable or retractable from the receptacle; and (4) a connecting terminal that is connected to the pigtail fiber, and to which external equipment is connected.

### TECHNICAL FIELD

The present invention relates to an optical fiber module that accommodates a functional optical fiber or the like, and comprises an optical connecting terminal for external optical equipment.

### BACKGROUND ART

An optical fiber module such as a dispersion compensating fiber module includes, for example, an optical fiber wounded into a coil shape and accommodated in a box-shaped receptacle and an input/output optical connecting terminal provided on a panel of the receptacle (for example, see Japanese Patent Application Laid-Open No. 2003-4951). A functional optical fiber such as a dispersion compensating fiber is usually wound on a bobbin or is placed in a receptacle in a manner in which it has been molded with resin. The input/output ends of the functional optical fiber are connected and anchored via excess length portions to optical connectors, connecting adapters, or the like provided on a front panel.

FIGS. 8A and 8B are perspective views showing an optical fiber module of the prior art, wherein FIG. 8A shows an example in which an optical connecting terminal is provided on a front panel, and FIG. 8B shows an example in which an optical connecting terminal is provided on the end of a pigtail fiber.

In an optical fiber module 1 of FIG. 8A, a connecting adaptor 3 for forming a connection using an optical connector is securely provided on a front panel of a receptacle 2, and is to be connected to another optical equipment via an optical fiber cord prepared separately. The optical fiber cord is equipped with optical connectors at the both ends thereof and detachably connected to the connecting adapter 3. However, connection loss occurs at the location of the connection.

In an optical fiber module 7 of FIG. 8B, a pigtail fiber 4 is guided to the receptacle 2 and fusion-spliced to a dispersion compensating fiber coil in the receptacle 2; and an optical connector 5 is connected to the outer end of the pigtail fiber. The pigtail fiber 4 is tightly anchored to a guiding part 6 of the receptacle 2, and therefore has a set length. For this reason, an obstruction will result if a pigtail fiber 4 is too long to be connected to external optical equipment. Conversely, if a pigtail fiber is too short, an additional optical fiber cord will be needed, inevitably leading to connection loss.

Patent Document 1: Japanese Patent Application Laid-Open No. 2003-4951

### DISCLOSURE OF THE INVENTION

### Problems which the Invention is Intended to Solve

It is an object of the present invention to provide an optical module that can be connected to external optical equipment with low loss, and in which excess length portion of a pigtail fiber does not cause an obstruction.

### Means Used to Solve the Above-Mentioned Problems

In order to attain this object, the present invention provides an optical fiber module including (1) a functional optical fiber; (2) a receptacle configured and arranged to accommodate the functional optical fiber; (3) a pigtail fiber that is connected to the functional optical fiber, and disposed so as to be extendable or retractable from the receptacle; and (4) a connecting terminal that is connected to the pigtail fiber, and to which external equipment is connected. The optical fiber module may further include an anchoring implement to hold an extension length of the pigtail fiber. The optical fiber module may further contain an excess-length take-up reel configured and arranged to wind up an excess length portion of the pigtail fiber in the receptacle. In this instance, a ratchet wheel configured and arranged to allow the excess-length take-up reel to rotate in a single direction is preferably further provided. The excess-length take-up reel is preferably urged by a spring to retract the pigtail fiber into the receptacle or the excess-length take-up reel is preferably arranged to be able to slide within the receptacle. In the optical fiber module, said pigtail fiber may have a loss of 0.1 dB or less at a wavelength of 1550 nm when wound ten turns with a diameter of 30 mm, a mode field diameter in a range of 8.2 μm to 9.0 μm at a wavelength of 1310 nm, a cable cutoff wavelength of 1260 nm or less, and a zero-dispersion wavelength in a range of 1300 nm to 1324 nm.

### ADVANTAGE OF THE INVENTION

According to the optical fiber module of the present invention, the pigtail fiber connected to the functional optical fiber extends out of the receptacle and connects directly to external optical equipment. Therefore, connection loss does not increase. In addition, excess length portion of the pigtail fiber is accommodated in the receptacle, whereby any variation in the distance between the receptacle and external optical equipment can be accommodated, and the connection can be made in an organized and aesthetically pleasing manner.

### BRIEF DESCRIPTION OF THE DRAWINGS

FIGS. 1A and 1B are perspective views of an embodiment of an optical fiber module according to the present invention;

FIGS. 2A and 2B are enlarged views of the vicinity of an opening of the embodiment of the optical fiber module according to the present invention;

FIG. 3 is a plan view of an interior of an embodiment of the optical fiber module according to the present invention;

FIGS. 4A and 4B are plan views of an interior of another embodiment of the optical fiber module according to the present invention;

FIG. 5 is a schematic view of an excess-length take-up reel used in another embodiment of the optical fiber module according to the present invention;

FIGS. 6A and 6B are schematic views of another excess-length take-up reel used in another embodiment of the optical fiber module according to the present invention;

FIG. 7 is a schematic view of another excess-length take-up reel used in another embodiment of the optical fiber module according to the present invention; and

FIGS. 8A and 8B are perspective views showing an optical fiber module of the prior art, wherein FIG. 8A shows an example in which an optical connecting terminal is provided on a front panel, and FIG. 8B shows an example in which an optical connecting terminal is provided on an end.

### KEY

11 optical fiber module
12 receptacle
12a front panel
13 pigtail fiber
13a excess length portion
14 optical connecting terminal (optical connector)
14a connecting adapter
15, 15′ opening
16 optical connector-equipped pigtail
16′ anchored optical connector-equipped pigtail
17 holding implement
18 module coil
18a input/output end
18b fiber connection
19 fiber connection-anchoring implement
20 anchoring implement
21 excess length take-up reel
22 anchoring implement
23 rotation shaft
24 ratchet wheel
25 locking pin
26 spring
27 rewinding spring
28 moving reel
29 operation member

### BEST MODE FOR CARRYING OUT THE INVENTION

An embodiment of the present invention will be described below with reference to the drawings. The drawings are used for descriptive purposes and do not limit the scope of the invention. In the drawings, the same symbols mark the same parts in order to avoid repeated descriptions. The ratios of dimensions in the drawings are not necessarily accurate.

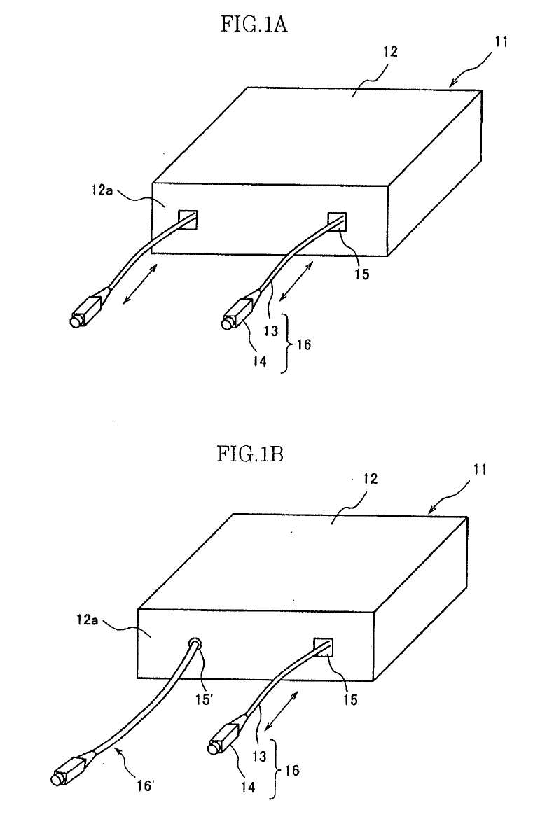

FIGS. 1A and 1B are perspective views of an embodiment of an optical fiber module according to the present invention. An optical fiber module 11 includes a pigtail fiber 13 which is guided to a receptacle 12 and connected with a functional optical fiber in the receptacle 12, similar to the optical fiber module 7 and the outer end of the pigtail fiber connects to an optical connector 14. The functional optical fiber, which has been wounded in a coiled shape, may be a dispersion compensating fiber (DCF), which has a chromatic dispersion of opposite sign to that of a transmission line and which compensates a chromatic dispersion of the transmission line; a rare-earth-doped optical fiber such as an erbium-doped fiber (EDF) for an optical fiber amplifier; and a highly non-linear fiber (HNLF), which can preform wavelength conversion of signal light having a plurality of wavelengths simultaneously or pulse compression.

The pigtail fiber 13 is what is called an optical fiber cord in which a single-core buffered optical fiber and a tension member applied to the periphery the fiber are covered by vinyl or another material. The cord is thin and lightweight; resistant to tensile force, compression forces, and bending; and is readily handled. The buffered optical fiber used herein may be the same optical fiber as the accommodated functional optical fiber, may be a standard single-mode optical fiber, or may be a specially made bend-insensitive optical fiber in the manner described below. The pigtail fiber 13 is disposed so as to be extendable or retractable with respect to an opening 15 formed in a front panel 12a of the receptacle 12. An inner end of the pigtail fiber 13 is directly connected to input or output end of the coiled functional optical fiber accommodated in the receptacle, and an optical connector 14 or another optical connecting terminal is connected to an outer end of the pigtail fiber. A pigtail fiber comprising the optical connecting terminal shall hereunder be referred to as an “optical connector-equipped pigtail 16.”

Both of the input side and output side optical connector-equipped pigtails 16 may be able to extend from and retract into the receptacle, as shown in FIG. 1A, or a fixed optical connector-equipped pigtail 16′ that cannot extend from or retract into the receptacle may also be used either for the input side or the output side as shown in FIG. 1B. In this instance, a guided part of the fixed optical connector-equipped pigtail 16′ is tightly anchored to an opening 15′.

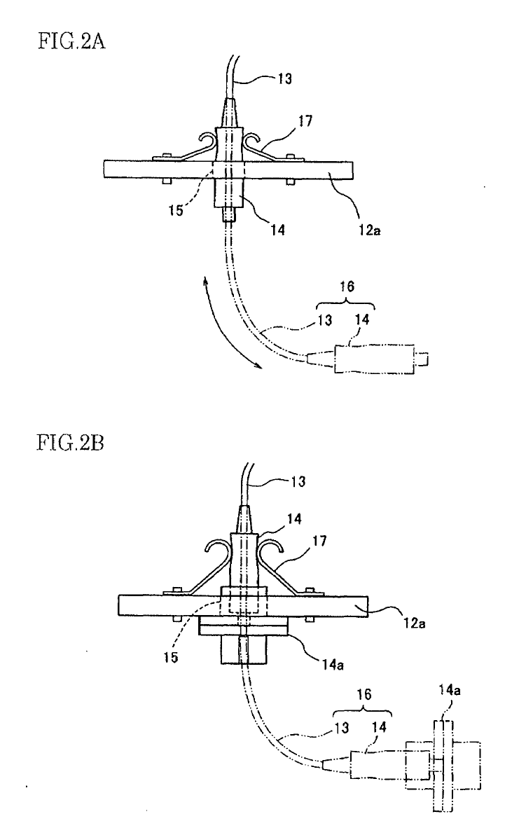

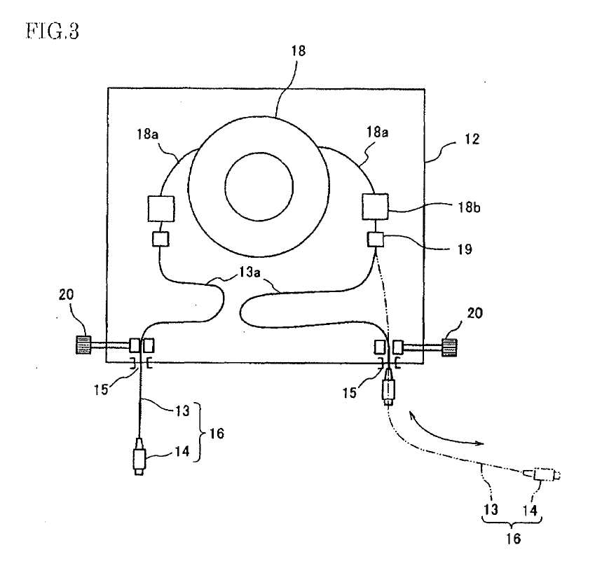

FIGS. 2A and 2B are enlarged views of the vicinity of an opening of the embodiment of the optical fiber module according to the present invention. The extendable and retractable optical connector-equipped pigtail 16 is elastically held in a detachable fashion in a retracted state (solid line) by a holding implement 17 provided inside of the opening 15 that is provided on the front panel 12a. In an extended state (double-dot dashed line), the optical connector 14 is removed from the holding implement 17 and extended out through the opening 15 to the front of the front panel 12a.

FIG. 2B shows an example in which the connecting adapter 14a is coupled to the optical connector 14, and the opening 15 to which the connecting adapter 14a can be affixed is disposed on the front panel 12a. In a retracted state (solid line), the optical connector 14 is elastically held in a detachable manner by the holding implement 17 provided inside of the opening 15. The connecting adapter 14a is integrally coupled with the optical connector 14 and is fitted into the opening 15. If external optical equipment that is to be connected has a pigtail fitted with an optical connector, the optical connector of the external optical equipment is inserted into and attached to the connecting adaptor 14a held by the opening 15, and an optical connection can be formed with the optical connector 14. In an extended state (double dot dashed line), the optical connector 14 is removed from the holding implement 17 and extended from the opening 15 to the front of the front panel 12a with the connecting adaptor 14a. The optical connector of the external optical equipment is inserted into and attached to the extended connecting adaptor 14a, and an optical connection is formed with the optical connector 14.

FIG. 3 is a plan view of an interior of an embodiment of the optical fiber module according to the present invention. A module coil 18 is formed by winding a functional optical fiber on a bobbin or winding the functional optical fiber without a bobbin and then molding using resin, and is held by a central part of the receptacle 12. Input/output ends 18a of the module coil 18 are directly connected to an end of the optical connector-equipped pigtail 16, and formed into a fiber connection 18b. The fiber connection 18b may be a fixed optical connection created by fusion splicing or mechanical splicing, or may be a removable optical connection using an optical connector.

An end portion of the optical connector-equipped pigtail 16 is anchored by a fiber connection-anchoring implement 19 in the vicinity of the fiber connection 18b. Anchoring can prevent a tensile force of the optical connector-equipped pigtail 16 from affecting the fiber connection 18b, and can prevent the input/output ends 18a of the module coil 18 from moving. The optical connector-equipped pigtail 16 is anchored so as not to move relative to the receptacle 12 in a manner such that loss will not increase with extensive lateral pressure placed on the fiber. The pigtail fiber 13 between the fiber connection-anchoring implement 19 and the optical connector 14 can have arbitrary length, and an excess length portion 13a of the pigtail fiber 13 is accommodated within the receptacle 12 in a slack state.

An anchoring implement 20 can be provided in the vicinity of the opening 15 for the optical connector-equipped pigtail 16. The anchoring implement 20 is, e.g., operatable from outside of the receptacle 12, suitably grips the pigtail fiber 13 in the vicinity of the opening 15, and can anchor with the pigtail fiber 13 in an extended or retracted state. The length of a portion of the optical connector-equipped pigtail 16 that has been extended out is adjusted by changing the position at which the pigtail fiber 13 is gripped by the anchoring implement 20. In addition, because the anchoring implement 20 grips the optical fiber 13, the excess length portion 13a of the pigtail fiber 13 can be maintain in a slack state in the receptacle and prevented from moving. The pigtail fiber 13 may be a cord that has a structure capable of holding a bend radius at which extensive bending loss does not occur.

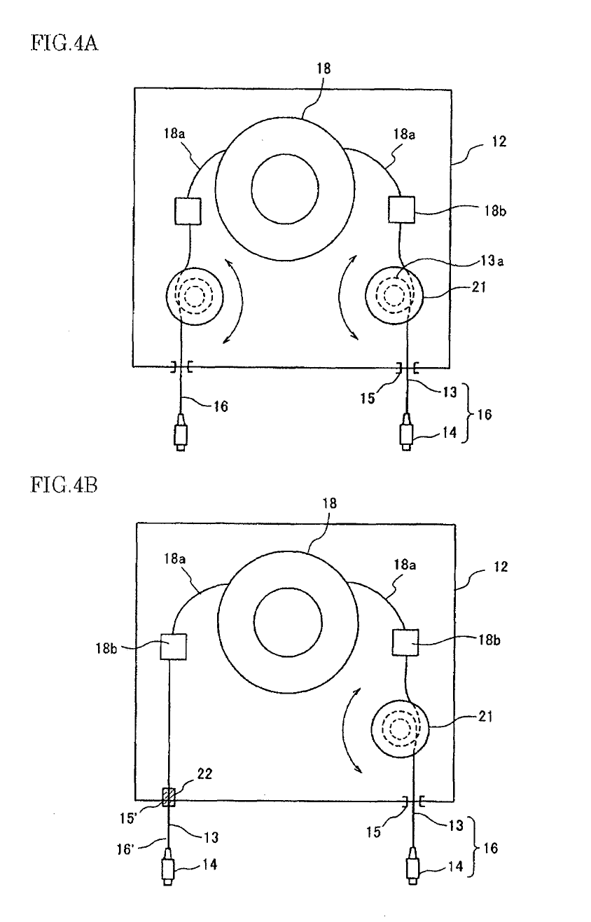

FIGS. 4A and 4B are plan views of an interior of another embodiment of the optical fiber module according to the present invention. In this instance, one end of the optical connector-equipped pigtail 16 may be anchored using the fiber connection-anchoring implement 19, or the fiber connection anchoring implement can be omitted because the anchoring is performed by an excess-length take-up reel 21. The excess-length take-up reel 21 is rotatably supported by the receptacle 12. The excess length portion 13a of the pigtail fiber 13 is wound up and accommodated in the excess-length take-up reel 21, whereby the pigtail fiber 13 can be accommodated without slacking. As a result, it becomes possible to avoid an instance in which the excess length portion 13a is raveled in the receptacle 12, whereby the pigtail fiber cannot be smoothly extended or retracted, or whereby loss increases due to lateral pressure.

The excess-length take-up reel 21 may be provided to both the input and output sides, as shown in FIG. 4A, or a configuration may also be adopted in which the excess-length take-up reel is provided to one of either the input or output side, and a fixed optical connector-equipped pigtail 16′ is provided to the other side, as shown in FIG. 4B. In the case of the latter, the pigtail fiber 13 is preferably anchored in the vicinity of the opening 15′ by an anchoring implement 22 or the like so that the tensile force of the pigtail fiber 13 will not directly affect the fiber connection 18b. A configuration may be adopted for the optical connector-equipped pigtail 16 wherein the anchoring implement 20 is provided in the vicinity of the opening 15 as described in FIG. 3, and the pigtail fiber 13 is prevented from moving.

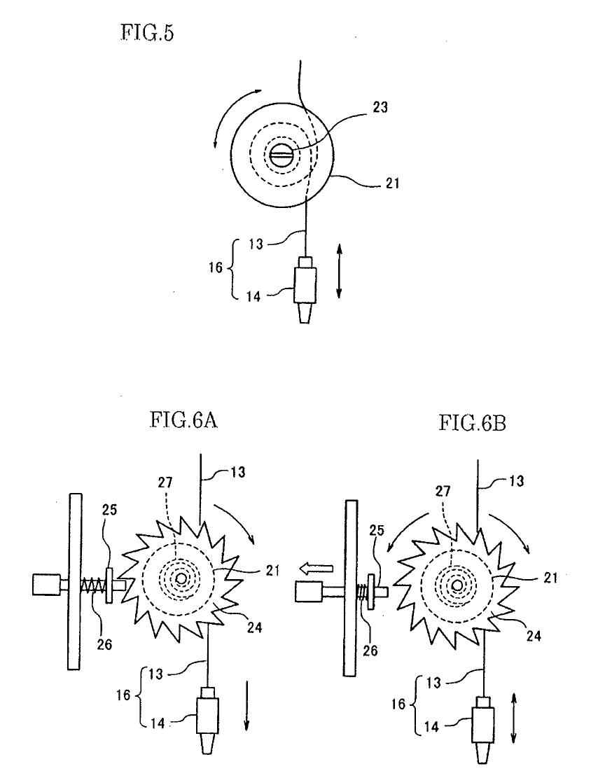

FIG. 5 is a schematic view of an excess-length take-up reel used in another embodiment of the optical fiber module according to the present invention. The excess-length take-up reel 21 may be rotated by the optical connector-equipped pigtail 16 that is extended from the receptacle 12 or retracted into the receptacle. In addition, a rotation shaft 23 that can be operated from the outside is preferably provided at the center of the excess-length take-up reel 21. The rotation shaft 23, e.g., is formed into a screw shape, is able to rotate the excess-length take-up reel 21 from the outside using a driver or the like, and is able to wind up or extend the pigtail fiber 13. If the rotation shaft 23 is tightened to halt the rotation of the excess-length take-up reel 21, the pigtail fiber 13 can be prevented from moving.

FIGS. 6A and 6B are schematic views of another excess-length take-up reel used in the other embodiment of the optical fiber module according to the present invention. When the optical connector-equipped pigtail 16 is pulled in the downward direction of the arrow, a ratchet wheel 24 rotates in a clockwise direction, the pigtail fiber 13 wound around the excess-length take-up reel 21 is rewound, and the optical connector 14 is extended, as shown in FIG. 6A. The ratchet wheel 24 is prevented from rotating in a counterclockwise direction by a locking pin 25, and the optical connector 14 is held in an extended state. When the locking pin 25 is moved against the force of a spring 26 and the ratchet wheel 24 is released from the lock, the ratchet wheel 24 can rotate in the counterclockwise direction, the optical connector-equipped pigtail 16 is wound around the excess-length take-up reel 21, and the optical connector 14 can be returned to the original state (the retracted state), as shown in FIG. 6B.

A rotation shaft that can be operated from the outside may be provided and rotated in order to cause the ratchet wheel 24 to rotate in the counterclockwise direction, as shown in FIG. 5. A configuration may also be adopted in which the ratchet wheel 24 is normally urged to rotate in the counterclockwise direction using a rewinding spring 27. According to this configuration, when the optical connector-equipped pigtail 16 is pulled back inside, the lock of the locking pin 25 is released whereby the excess-length take-up reel 21 automatically winds and retracts the pigtail fiber 13. In either configuration, the pigtail fiber 13 can be automatically wound around the excess-length take-up reel 21 using the rewinding spring 27.

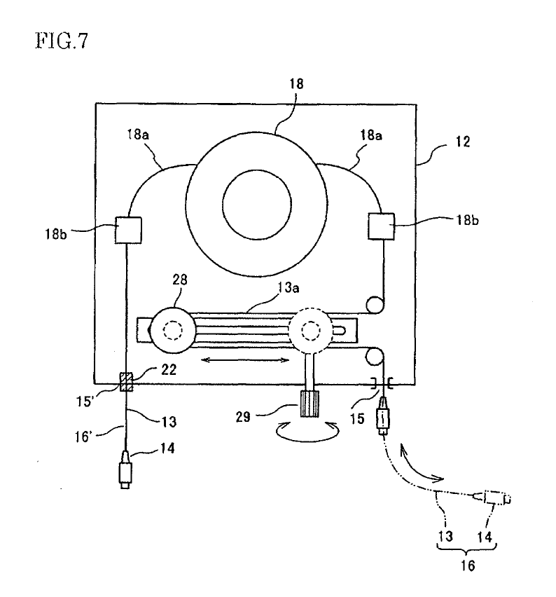

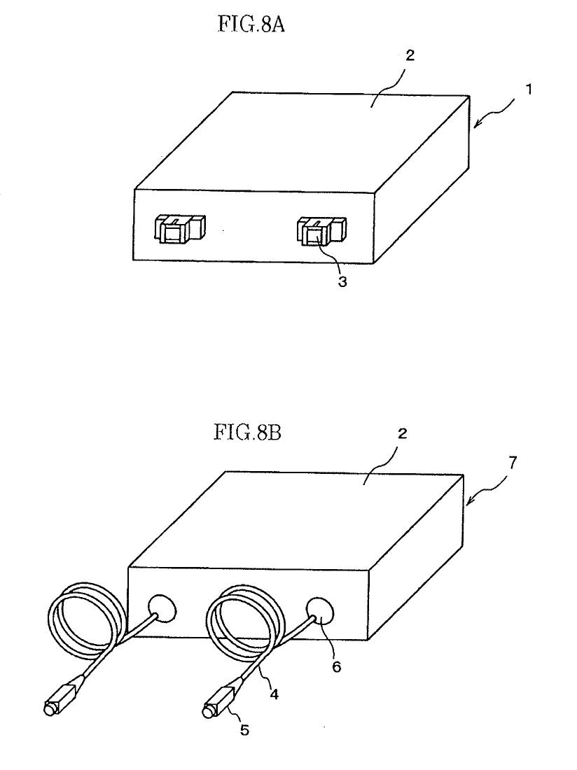

FIG. 7 is a schematic view of another excess-length take-up reel used in another embodiment of the optical fiber module according to the present invention. A moving reel 28 which is the same configuration as the excess-length take-up reel 21 described in FIGS. 4A, 4B, 5, 6A, 6B and can wind up the excess length portion 13a of the pigtail fiber 13 is mounted slidable in the receptacle 12. A slide movement mechanism can be a mechanism for converting the rotational movement of a rack or the like to linear movement, and can be slide in the lateral direction via the rotation of an operation member 29.

In the optical fiber module comprising the excess-length take-up reel shown in FIG. 7, when the optical connector-equipped pigtail 16 is extended from the receptacle 12, the operation member 29 is rotated and the moving reel 28 slides from a position on the left side to a position on the right side, whereby the excess length portion 13a of the pigtail fiber 13 is shortened and extended outward. When the optical connector-equipped pigtail 16 is retracted into the receptacle 12, the moving reel 28 slides from the position on the right side to the position on the left side, and an accommodated length portion of the excess length portion 13a of the pigtail fiber 13 is thereby increased. In FIG. 7, in order to prevent more space occupied with the mechanism for moving the moving reel 28, only one optical connector-equipped pigtail 16 is wound on the moving reel and the other optical connector-equipped pigtail 16′ is not wound on the moving reel. However, the mechanism for moving the moving reel 28 can be used for both optical connector-equipped pigtails by being arranged into dual-layered or two-row configurations.

In order to be accommodated within the receptacle 12, the pigtail fiber 13 of the optical connector-equipped pigtail 16 is preferably a fiber that does not exhibit an increase in loss even when it is bent in a small diameter. In the prior art, a normal single mode optical fiber (SMF) is used for the pigtail fiber in an anchored optical connector-equipped pigtail. Such a fiber has a mode field diameter MFD_{1.31} at a wavelength of 1310 of about 9.2 μm, and bending loss α_{bend} at a wavelength of 1550 nm of 0.17 dB under being wound ten turns with a bending radius of 15 mm, as shown by a comparative example in Table 1. For this reason, in the prior art, the bending radius must be 30 mm or greater so that the bending loss is 0.1 dB or less.

In the present invention, optical fiber having a mode field diameter MFD_{1.31} of in a range of 8.2 μm to 9.0 μm and a bending loss α_{bend} of 0.1 dB or less, such as the examples of optical fibers (examples 1, 2, 3) in Table 1, is preferably used. The cable cutoff wavelength λ_{c} of these optical fibers is 1260 nm or less, and the zero dispersion wavelength d₀ is in a range of 1300 nm to 1324 nm. Other optical characteristics (dispersion slope dₛₗₒₚₑ at a zero dispersion wavelength, transmission loss α_{1.31} at a wavelength of 1310 nm, transmission loss α_{1.38} at a wavelength of 1380 nm, and transmission loss α_{1.55} at a wavelength of 1550 nm) meet the ITU-T G.652 recommendation in the same manner as the SMF of the prior art. “Pure-Access” (product name) manufactured by Sumitomo Electric Industries, Ltd is an example of an optical fiber having these types of optical characteristics.

TABLE 1

| | | | | Comparative |
|---|---|---|---|---|
| | | | | Example |
| | Example 1 | Example 2 | Example 3 | Ge-doped |
| Core material | Pure silica | Pure silica | Ge-doped silica | silica |
| Δ % | 0.39 | 0.385 | 0.42 | 0.34 |
| Δ α_{bent} dB | 0.03 | 0.06 | 0.01 | 0.17 |
| MFD_{1.31} μm | 8.53 | 8.72 | 8.60 | 9.19 |
| λ_{c} nm | 1170 | 1184 | 1200 | 1174 |
| d₀ | 1318 | 1312 | 1312 | 1313 |
| Dₛₗₒₚₑ ps/nm²/km | 0.079 | 0.081 | 0.085 | 0.088 |
| α_{1.31} dB/km | ≦0.32 | ≦0.32 | ≦0.35 | 0.33 |
| α_{1.38} dB/km | ≦0.31 | ≦0.31 | ≦0.33 | 0.31 |
| α_{1.55} dB/km | ≦0.176 | ≦0.176 | ≦0.21 | 0.196 |

The use of a bend-insensitive optical fiber, such as those described above, as the pigtail fiber of the optical fiber module of the present invention enables the diameter of a drum of the excess-length take-up reel to be reduced, and the excess length portion to be compactly arranged and accommodated within the limited receptacle. The use of the optical fiber enables increases in loss in the optical fiber module to be minimized and enables the same optical characteristics to be realized as in the prior art.

All information disclosed in the specification, claims, drawings, and abstract of Japanese Patent Application No. 2005-015279 (filed on Jan. 24, 2005) is incorporated in the present specification.

### INDUSTRIAL APPLICABILITY

The optical fiber module of the present invention accommodates a dispersion compensating fiber (DCF), a rare-earth-doped optical fiber, or a highly non-linear fiber (HNLF), and can be used in an optical transmission line.

What is claimed is:

1. An optical fiber module comprising:
(1) a functional optical fiber;
(2) a receptacle configured and arranged to accommodate said functional optical fiber;
(3) a pigtail fiber that is connected to said functional optical fiber, and disposed so as to be extendable or retractable from said receptacle; and
(4) a connecting terminal that is connected to said pigtail fiber, and to which external equipment is connected.

2. The optical fiber module of claim 1, further comprising
an anchoring implement configured and arranged to hold an extension length of said pigtail fiber.

3. The optical fiber module of claim 1, further comprising
an excess-length take-up reel disposed inside said receptacle and configured and arranged to wind up an excess length portion of said pigtail fiber.

4. The optical fiber module of claim 3, further comprising
a ratchet wheel configured and arranged to allow said excess-length take-up reel to rotate in a single direction.

5. The optical fiber module of claim 3, wherein
said excess-length take-up reel is urged by a spring to retract said pigtail fiber into said receptacle.

6. The optical fiber module of claim 3, wherein
said excess-length take-up reel is arranged to be able to slide within said receptacle.

7. The optical fiber module of claim 1, wherein
said pigtail fiber has a loss of 0.1 dB or less at a wavelength of 1550 nm when wound ten turns with a diameter of 30 mm, a mode field diameter in a range of 8.2 μm to 9.0 μm at a wavelength of 1310 nm, a cable cutoff wavelength of 1260 nm or less, and a zero-dispersion wavelength in a range of 1300 nm to 1324 nm.

8. The optical fiber module of claim 2, further comprising
an excess-length take-up reel disposed inside said receptacle and configured and arranged to wind up a surplus length of said pigtail fiber.

9. The optical fiber module of claim 8, further comprising
a ratchet wheel configured and arranged to allow said excess-length take-up reel to rotate in a single direction.

10. The optical fiber module of claim 8, wherein
said pigtail fiber is urged to retract into said receptacle by a spring in said excess-length take-up reel.

11. The optical fiber module of claim 8, wherein
said excess-length take-up reel is arranged to be able to slide within said receptacle.
